(19) United States
(12) Patent Application Publication
(10) Pub. No.: US 2011/0185090 A1
(43) Pub. Date: Jul. 28, 2011

(54) Apparatus for Translating and Expanding Inputs for a Point Of Sale Device

(76) Inventor: Marat Kushnir, Sharon, MA (US)

(21) Appl. No.: 12/692,946

(22) Filed: Jan. 25, 2010

(51) Int. Cl. G06F 13/42

(52) U.S. Cl. 710/105

(57) ABSTRACT

An apparatus includes a PS2 input for receiving first input logic signals from a first device. A USB input receives second input logic signals from a second device. A RS232 input receives third input logic signals from a third device. A TTL input receives fourth input logic signals from a fourth device. A programmed logic circuit translates the first input logic signals, the second input logic signals, the third input logic signals and the fourth input logic signals to first output logic signals having a RS232 output. The programmed logic circuit further translates the first input logic signals, the second input logic signals, the third input logic signals and the fourth input logic signals to second output logic signals having a TTL output. A RS232 output transmits the first output logic signals to a POS device and a TTL output transmits the second output logic signals to a POS device. Input Ports for logic signals may be distinct in cases where a signal translation function is sought. Input Ports for logic signals may also be repeated for the same input logic where an expansion function is sought.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

The present invention relates generally to electronic devices. More particularly, the invention relates to an interface to connect keyboards and other peripheral devices to point of sale (POS) devices.

### BACKGROUND OF THE INVENTION

The present invention provides expanded functionality to a Point of Sale (POS) device. The present invention also enables devices such as, but not limited to, POS devices, which typically have a limited type and number of input ports, to be used with a keyboard allowing the easy capture of alphanumeric data such as, but not limited to, name, address, email, phone number, etc. The ability to capture alphanumeric data and other special symbols in an efficient and fast manner allows a POS device to be used for a variety of applications which would otherwise be tedious or not possible.

A POS device typically consists of any or all of the following components: a display, a keypad, a printer, a magnetic stripe reader, a smart card reader, a modem, etc. The following salient features regarding a POS device are discussed below with reference to the apparatus: the keypad, the operating system and the communication interfaces. The POS apparatus is usually a single enclosure, although sometimes more than one enclosure is used, and is typically designed for banking applications for example, without limitation, processing credit/debit cards. A failure in any of the components of a POS device normally renders the device dysfunctional and the entire device must be repaired or replaced. The keypad is designed for the fast capture of numeric data. In some instances character data can be captured using function keys or by tapping the same keys several times in order to obtain a desired character. In any event capturing characters in a POS device is tedious or impossible. A POS keypad typically comprises about 20 keys and rarely has more than 35 keys. The operating system used on the device is usually developed by the manufacturer and is sold together with the POS device. Such operating systems are not typically available off the shelf for purchases and cannot typically be used with the devices of other manufacturers. Although the software drivers of the various components may be generic, for a respective POS, when all the assembled parts are put together and its application is compiled, the application will generally not work with other types of hardware. Hence it is a closed system. POS devices typically include one or more of the following communication interfaces: RS232 (Recommended Standard 232), TTL (Transistor-Transistor Logic), RS485 (Recommended Standard 485), Ethernet and Telephone connections. Peripheral Devices, which utilize different communications interfaces such as PS/2 or USB (Universal Serial Bus), cannot connect to current POS devices as they are not compatible with the existing communication interfaces. It is therefore an objective of the present invention to provide an interface that enables peripheral devices using different communication interfaces to be connected to a POS device.

Peripheral devices include any additional devices that may be used in a retailing environment including, but not limited to, keyboards, scales, scanners, card readers, receivers, transmitters, check readers, biometric scanners, etc. Peripheral devices may have typical POS communication interfaces such as RS232 or TTL or may have different communication interfaces such as, but not limited to, PS/2 or USB. An RS232 communication interface is a standard for serial binary data signals connecting a DTE (Data Terminal Equipment) and a DCE (Data Circuit-terminating Equipment). It is commonly used in computer serial ports. Connectors vary and may typically consist of three to five wire connections; however, two wire connections can be used for certain applications and as many as ten wires may be used with more elaborate devices and protocols. Typical signal levels are ±3V, ±5 V, ±10 V, ±12 V, and ±15 V depending on power supplies within a device and normally can withstand voltage levels up to ±25 volts. TTL is widely used in integrated circuits for many applications such as computers, industrial controls, instrumentation, and consumer electronics. Typically TTL circuits operate with a 5 V power supply with a low input signal range of 0 V to 0.8 V and a high signal range of 2.2 V to 5 V. TTL outputs are typically restricted to narrower limits of between 0 V and 0.4 V for a low and between 2.6 V and 5 V for a high with 0.4 V for noise. A PS/2 connector is typically used to connect keyboards to computers. The connector comprises six pins and passes a serial data signal at 10 kHz to 16 kHz with one stop bit, one start bit, and one odd parity bit. A PS/2 connector operates at a voltage of +5V DC at 275 mA. USB is a serial bus standard to connect devices to a host computer. USB is designed to allow many peripherals to be connected using a single standardized interface socket and to improve plug and play capabilities by allowing devices to be connected and disconnected without rebooting the computer or turning off the device. Other typical features of USB include providing power to low-consumption devices and allowing many devices to be used without requiring manufacturer-specific device drivers to be installed. The wiring typically consists of four cables, although more cables can be used with different USB versions. Power supplied to USB is normally between 4.75 V to 5.25 V with currents between 100 mA to 500 mA. In low speed mode, the transmitted signal levels are typically 0.0 V to 0.3 V for low and 2.8 V to 3.6 V for high. While in high-speed modes, 10 mV is typically used for low and 360 mV to 440 mV is typically used for high.

In the past there have been attempts to capture alphanumeric data on POS devices or similar devices by tapping multiple times on the same key in a specified period of time allowing for the scrolling of various letters. For example, without limitation, if a user wishes to select the letter “C” on a typical numeric keypad, he would tap the number-2 key three times, which would change the input from “2” to “A” to “B” and finally to the letter “C”. Other attempts allow a user to scroll through a screen until the desired letter or symbol is found. Devices without a keyboard also have additional restrictions such as, but not limited to, difficulty in changing between capital and lower case letters, tedious selection of various symbols such as, but not limited to @, $, #, and /, and there may be no keys for functions such as, but not limited to, Delete, Backspace, Scroll Left, Scroll Right, etc. or it may require difficult maneuvering to perform these functions.

In view of the foregoing, there is a need for improved techniques for connecting peripheral devices, including, but not limited to, devices that enable the easy input of alphanumeric data, to a POS device using various different communication interfaces.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates an exemplary external interface attached to a POS terminal enabling the usage of a computer keyboard, in accordance with an embodiment of the present invention;

FIG. 2 illustrates an exemplary POS device with an internal integrated interface, in accordance with an embodiment of the present invention;

FIG. 3 is a functional matrix diagram of an exemplary interface for a POS device, in accordance with an embodiment of the present invention;

FIG. 4 is a technical diagram illustrating an exemplary logical design for an exemplary interface and its various functions, in accordance with an embodiment of the present invention; and

FIG. 5 is a functional matrix diagram illustrating multiple interfaces connected using a daisy chaining method, in accordance with an embodiment of the present invention.

Unless otherwise indicated illustrations in the figures are not necessarily drawn to scale.

### SUMMARY OF THE INVENTION

To achieve the forgoing and other objects and in accordance with the purpose of the invention, an apparatus for translating and expanding inputs for a point of sale device is presented.

In one embodiment an apparatus includes means for receiving first input logic signals having a first input signal protocol, means for translating the first input logic signals to first output logic signals having a first output signal protocol, and means for transmitting the first output logic signals. Another embodiment further includes means for receiving second input logic signals having a second input signal protocol, wherein the means for translating translates the first input logic signals and the second input logic signals to first output logic signals having the first output signal protocol. Yet another embodiment further includes means for transmitting second output logic signals, wherein the means for translating translates the first input logic signals and the second input logic signal to first output logic signals having the first output signal protocol and to second output logic signals having a second output signal protocol. Still another embodiment further includes means for receiving third input logic signals having the first output signal protocol, wherein the means for translating further passes the third input logic signals to first output logic signals having the first output signal protocol and further translates the third input logic signals to second output logic signals having the second output signal protocol. Another embodiment further includes means for receiving fourth input logic signals having the second output signal protocol, wherein the means for translating further passes the fourth input logic signals to second output logic signals having the second output signal protocol and further translates the fourth input logic signals to first output logic signals having the first output signal protocol.

In another embodiment an apparatus includes a first input for receiving first input logic signals from a first device configured for transmitting user inputs, the first logic input signals having a first input signal protocol. A programmed logic circuit translates the first input logic signals to first output logic signals having a first output signal protocol. A first output transmits the first output logic signals to a receiving device configured for receiving user inputs. In another embodiment the first logic input signals have a second input signal protocol. In yet another embodiment the programmed logic circuit translates the first input logic signals to first output logic signals having a second output signal protocol. Still another embodiment further includes a second input for receiving second input logic signals from a second device configured for transmitting user inputs, the second input signals having a second input signal protocol, wherein the programmed logic circuit translates the first input logic signals and the second input logic signals to first output logic signals having the first output signal protocol. In another embodiment the programmed logic circuit translates the first input logic signals and the second input logic signals to first output logic signals having a second output signal protocol. Yet another embodiment further includes a second output for transmitting second output logic signals to a receiving device configured for receiving user inputs, wherein the programmed logic circuit translates the first input logic signals and the second input logic signal to first output logic signals having the first output signal protocol and to second output logic signals having a second output signal protocol. Still another embodiment further includes a third input for receiving third input logic signals from a third device configured for transmitting user inputs, the third input signals having the first output signal protocol, wherein the programmed logic circuit further passes the third input logic signals to first output logic signals having the first output signal protocol and further translates the third input logic signals to second output logic signals having the second output signal protocol. Another embodiment further includes a fourth input for receiving fourth input logic signals from a fourth device configured for transmitting user inputs, the fourth input signals having the second output signal protocol, wherein the programmed logic circuit further passes the fourth input logic signals to second output logic signals having the second output signal protocol and further translates the fourth input logic signals to first output logic signals having the first output signal protocol. Yet another Another embodiment further includes a multichannel driver/receiver for multiplexing input and output logic signals. Still another embodiment further includes signal conditioners associated with inputs and outputs. Another embodiment further includes control switches for affecting programming of the programmed logic circuit. Yet another embodiment further includes display indicators for indicating status of inputs and outputs.

In another embodiment an apparatus includes a PS2 input for receiving first input logic signals from a first device configured for transmitting user inputs. A USB input receives second input logic signals from a second device configured for transmitting user inputs. A RS232 input receives third input logic signals from a third device configured for transmitting user inputs. A TTL input receives fourth input logic signals from a fourth device configured for transmitting user inputs. A programmed logic circuit translates the first input logic signals, the second input logic signals, the third input logic signals and the fourth input logic signals to first output logic signals having a RS232 output signal protocol. The programmed logic circuit further translates the first input logic signals, the second input logic signals, the third input logic signals and the fourth input logic signals to second output logic signals having a TTL output signal protocol. A RS232 output transmits the first output logic signals to a POS device configured for receiving such inputs. A TTL output transmits the second output logic signals to a POS device configured for receiving such inputs. Another embodiment further includes a multichannel driver/receiver for multiplexing input and output logic signals. Yet another embodiment further includes signal conditioners associated with inputs and outputs.

Other features, advantages, and object of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

The present invention will now be described in detail with reference to embodiments thereof as illustrated in the accompanying drawings.

Detailed descriptions of the preferred embodiments are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

Preferred embodiments of the present invention provide expanded functionality to a Point of Sale (POS) device. Using preferred embodiments of the present invention, POS devices and similar devices, which have limited interfaces, can be connected to a keyboard or other peripherals. Preferred embodiments enable a POS or similar device to be connected to devices, whose interface protocol is not typically supported by such a device, alongside other device peripherals that are typically supported. Preferred embodiments also allow for the connectivity of multiple peripherals, which would otherwise be problematic due to the limited number of available ports on a typical POS device.

Preferred embodiments of the present invention provide a functional interface which allows peripherals with PS/2 or USB interfaces to be connected to a POS device or other such similar devices as well as multiple peripherals using RS232 or TTL interfaces. This allows for connectivity of a wider and less expensive array of peripherals. In some preferred embodiments, an interface is disclosed that enables a POS device to be used with a keyboard allowing the easy capture of alphanumeric data such as, but not limited to, name, address, email, etc. The ability to capture alphanumeric data and other special symbols in an efficient and fast manner allows a POS device to be used for a variety of applications such as, but not limited to, recording customer information, capturing email addresses, filling in forms, filling in surveys, applying for credit cards, etc. In preferred embodiments, the interface maybe external and may be applied to existing POS devices, or the interface may be internally integrated into a circuit of a POS device. Furthermore, the interface in some preferred embodiments does not only provide a signal translation function (i.e., USB or PS/2 into RS232 or TTL as is commonly used by POS devices); the interface may also serve an expansion function if used externally. The expansion is achieved by allowing multiple interfaces to be daisy chained together allowing additional TTL/RS232 peripherals such as, but not limited to, keyboards, barcode scanners, infrared receivers/transmitters, scanners, scales, biometric readers, proximity card readers, or the like to be connected to a POS device.

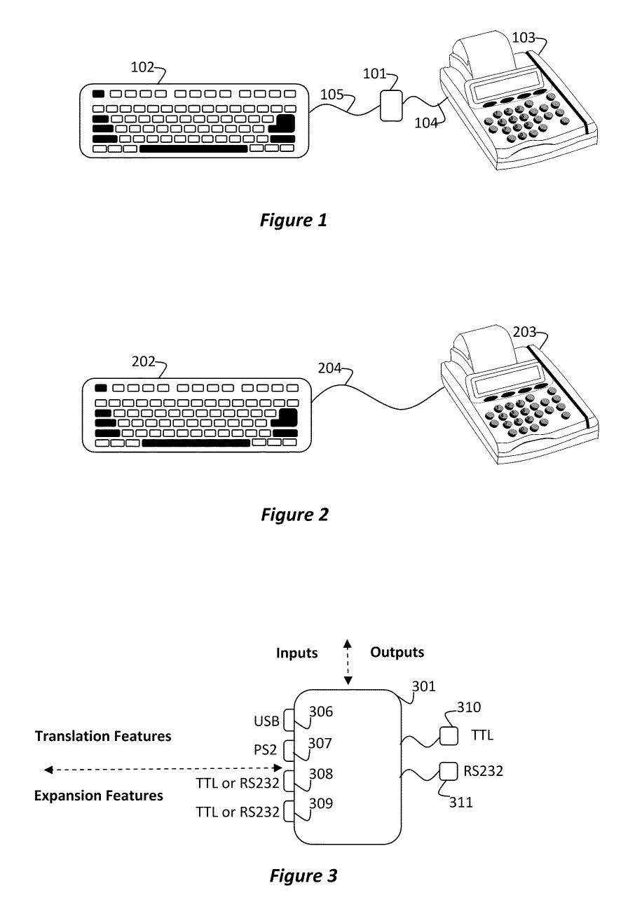

FIG. 1 illustrates an exemplary external interface 101 attached to a POS terminal 103 enabling the usage of a computer keyboard 102, in accordance with an embodiment of the present invention. In the present embodiment, interface 101 not only provides interface functionality for keyboard 102 but it may also enable other peripheral devices such as, but not limited to, scales, scanners, card readers, receivers, transmitters, check readers, biometric scanners, etc. to be connected to POS device 103. Interface functionality in the present embodiment is provided externally with a separate circuit and enclosure. Interface 101 is connected to POS device 103 with cable 104 and to keyboard 102 with cable 105.

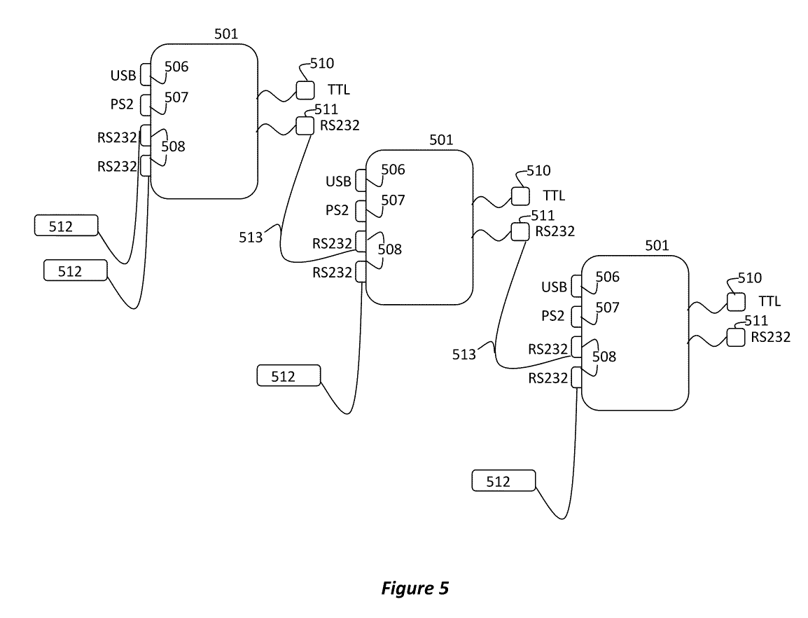

Interface 101 provides two independent features, namely translation and expansion. The translation feature changes the input of one signal type to another signal type while the expansion feature allows for the addition of multiple peripherals or other interfaces. The translation feature is attained in both an internal and an external interface. The expansion feature, however, is only available in external interface 101 where multiple external interfaces can be daisy chained together to allow multiple peripherals to be connected to a device with limited RS232 or TTL ports, as shown by way of example in FIG. 5. The translation and expansion features are achieved through program logic within the microprocessor and multiplexing of signals between the various peripherals and POS device 103.

FIG. 2 illustrates an exemplary POS device 203 with an internal integrated interface, in accordance with an embodiment of the present invention. In the present embodiment the interface is internally integrated into an existing circuit of POS device 203. This enables the attachment of a computer keyboard 202 or other such device with a cable 204. The translation feature of the internal interface changes the input of one signal type to another signal type. The expansion feature provided by an external interface is not provided by an internal interface as multiple internal interfaces may not be daisy chained together to provide additional connection ports. The translation feature is achieved through program logic within the microprocessor and the multiplexing of signals between the various peripherals and POS device 203.

FIG. 3 is a functional matrix diagram of an exemplary interface 301 for a POS device, in accordance with an embodiment of the present invention. This illustration of a functional matrix for an external interface 301 comprises a USB input 306, a PS/2 input 307 and two TTL or RS232 inputs 208 and 209. Peripheral devices are plugged into inputs 306, 307, 308, and 309 to be connected to a POS device. Interface 301 also comprises a TTL output 310 and an RS232 output 311 that may directly connect to the POS device. Interface 301 takes the signals from inputs 306, 307, 308, and 309 and translates them into TTL or RS232 signals, which the POS device can recognize, and transmits these signals though outputs 310 and 311 to the POS device.

Those skilled in the art, in light of the present teachings, will readily recognize that interfaces in alternate embodiments may have various different types of input and output ports in various different configurations. For example, without limitation, communication interfaces other than RS232, TTL, USB and PS/2 may be used in some alternate embodiments such as, but not limited to, RS422, RS423, RS449, RS485, MILSTD-188, EIA530, EIA561, EIA562, TIA574 etc. Some non-limiting examples of interfaces with differing input/output configurations are as follows: an interface with either a PS/2 or a USB input and RS232 output, an interface with either a PS/2 or a USB input and a TTL output, an interface with both a PS/2 and a USB input and an RS232 output, an interface with both a PS/2 and a USB input and a TTL output, and an interface with both a PS/2 and a USB input and both an RS232 and a TTL output. Also, some alternate embodiments may comprise multiple ports of each type.

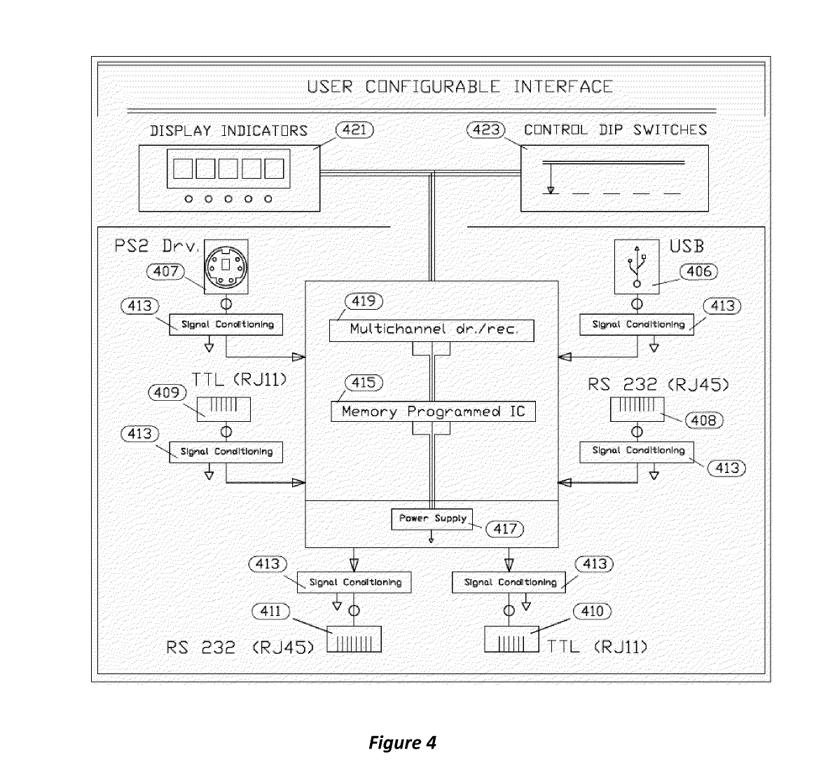

FIG. 4 is a technical diagram illustrating an exemplary logical design for an exemplary interface and its various functions, in accordance with an embodiment of the present invention. The present embodiment provides for an interface functionality that allows a typical computer keyboard or other peripheral device with a USB, PS/2, RS232 or TTL interface to be connected to a POS device or any such device that has either a TTL or RS232 port. The interface functionality may be internally integrated into an existing circuit of a POS device as shown by way of example in FIG. 2, or it can be provided externally using its own circuit and enclosure, which can be connected to an existing POS device, as shown by way of example in FIG. 1. The interface functionality of the invention provides a translation feature and an expansion feature. The translation feature changes the input of one signal type to another signal type. Input signals in the present embodiment may be USB, PS/2, TTL or RS232, and output signals may be TTL or RS232. The expansion feature allows for the addition of multiple peripherals.

Referring to FIG. 4, the interface comprises a USB input 406, a PS/2 input 407, an RS 232 input 408, and a TTL input 409. The signals coming into the interface through these inputs pass though signal conditioners 413 before reaching an integrated circuit 415 with it's own power supply 417. Signal conditioning is achieved by using a number of coils and ferrite based shield absorbers which disallow electromagnetic energy to enter or exit along the main cabling. The radio frequency (RF) absorbing properties of these coils interact with high frequency energy and effectively dissipate unwanted RF while allowing data signals to pass unimpeded. The RF interferences we are aiming to eliminate include such things as electric motors and/or fluorescent lighting which are frequently found in offices or other businesses. Integrated circuit 415 is memory programmed and is connected to a multichannel Driver (dr.)/Receiver (rec) 419. The driver and the receiver form an integral part of the multichannel circuit which, for example, enables the functioning of USB protocol devices and the analysis of received signals for processing. Integrated circuit 415 takes the signals from the various inputs and converts the signals to signals that are compatible with TTL and RS232. The signals are then sent through signal conditioners 413 and transmitted by a TTL output 310 or an RS232 output 311. Integrated circuit 415 also sends signals to display indicators 421 and control dip switches 423. The user interface may include Control (DIP switches) and a number of display indicators. In some embodiments the display indicators can provide feedback regarding the status of the device while the DIP switches enable adjustable settings of integrated circuit 415 depending on the present interfaces. Such adjustments could be based on local conditions and/or the available peripherals and could be implemented by the user or alternatively it could be prepared and programmed ahead of time and distributed as such. In instances where programming for the required interfaces occurs ahead of time only the display may be activated while the DIP switches could be concealed, ignored or left open for user interaction. In cases where the given input/output interfaces don't require extensive flexibility, the invention could be constructed in a simpler form ignoring the need for DIP switches and display indicators.

FIG. 5 is a functional matrix diagram illustrating multiple interfaces 501 connected using a daisy chaining method, in accordance with an embodiment of the present invention. This daisy chaining method is used to achieve an expansion function allowing for connectivity of multiple peripherals 512. Interfaces 501 are external interfaces with their own circuits and enclosures each comprising a USB input 506, a PS/2 input 507, two RS232 inputs 508, a TTL output 510 and a RS232 output 511. Cables 513 connect an RS232 input 508 of one interface 501 to an RS232 output 511 of another interface 501 to create the daisy chain. In the present embodiment, interfaces 501 only comprise RS232 inputs 508; however, alternate embodiments may comprise TTL inputs or other types of inputs that may enable daisy chaining, depending on the configuration of the interface. In addition, multiple peripherals 512 may be attached to the free RS 232 inputs 508 of interfaces 501. Other peripherals may also be attached to USB inputs 506 and PS/2 inputs 507 of the interfaces.

There are many situations where implementing preferred embodiments of the present invention is advantageous. In one non-limiting example, there are certain services or products such as, but not limited to, an “Off the Shelf Credit Card”, which cannot be sold over the counter by retailers. Legislation prevents such negotiable instruments to be used by “Anonymous Persons”. Preferred embodiments of this invention allows retailers to verify a person's identity and quickly capture a person's name, identity number, date of birth, license number, email, etc. in order to comply with any legislation. In another non-limiting example, a person may wish to transfer money to a recipient whose details need to be captured. Preferred embodiments of this invention enable the sender and recipient to capture their personal details and banking information as easily as they could by using a PC with a monitor and keyboard. In another non-limiting example, population data such as births, deaths, marriages, arrests, pension claims, hospital admissions or the like can be captured by specially configured POS devices with a keyboard and transmitted from rural or mobile locations to central locales without the need for costly remote computer installations, local area networks, or wide area networks.

Having fully described at least one embodiment of the present invention, other equivalent or alternative methods of providing an interface with translation and expansion features according to the present invention will be apparent to those skilled in the art. The invention has been described above by way of illustration, and the specific embodiments disclosed are not intended to limit the invention to the particular forms disclosed. For example, the particular implementation of the interface may vary depending upon the particular type of device used. The devices described in the foregoing were directed to POS implementations; however, similar techniques are to provide interfaces with similar functions to different types of devices including, but not limited to, inventory management devices, measuring instruments, etc. Non-POS implementations of the present invention are contemplated as within the scope of the present invention. The invention is thus to cover all modifications, equivalents, and alternatives falling within the spirit and scope of the following claims.

Claim elements and steps herein have been numbered and/or lettered solely as an aid in readability and understanding. As such, the numbering and lettering in itself is not intended to and should not be taken to indicate the ordering of elements and/or steps in the claims.

What is claimed is:

1. An apparatus comprising:
means for receiving first input logic signals having a first input signal protocol;
means for translating said first input logic signals to first output logic signals having a first output signal protocol; and
means for transmitting said first output logic signals.

2. The apparatus as recited in claim 1, further comprising means for receiving second input logic signals having a second input signal protocol, wherein said means for translating translates said first input logic signals and said second input logic signals to first output logic signals having said first output signal protocol.

3. The apparatus as recited in claim 2, further comprising means for transmitting second output logic signals, wherein said means for translating translates said first input logic signals and said second input logic signal to first output logic signals having said first output signal protocol and to second output logic signals having a second output signal protocol.

4. The apparatus as recited in claim 3, further comprising means for receiving third input logic signals having said first output signal protocol, wherein said means for translating further passes said third input logic signals to first output logic signals having said first output signal protocol and further translates said third input logic signals to second output logic signals having said second output signal protocol.

5. The apparatus as recited in claim 4, further comprising means for receiving fourth input logic signals having said second output signal protocol, wherein said means for translating further passes said fourth input logic signals to second output logic signals having said second output signal protocol and further translates said fourth input logic signals to first output logic signals having said first output signal protocol.

6. An apparatus comprising:
a first input for receiving first input logic signals from a first device configured for transmitting user inputs, said first logic input signals having a first input signal protocol;
a programmed logic circuit for translating said first input logic signals to first output logic signals having a first output signal protocol; and
a first output for transmitting said first output logic signals to a receiving device configured for receiving user inputs.

7. The apparatus as recited in claim 6, wherein said first logic input signals have a second input signal protocol.

8. The apparatus as recited in claim 6, wherein said programmed logic circuit translates said first input logic signals to first output logic signals having a second output signal protocol.

9. The apparatus as recited in claim 6, further comprising a second input for receiving second input logic signals from a second device configured for transmitting user inputs, said second input signals having a second input signal protocol, wherein said programmed logic circuit translates said first input logic signals and said second input logic signals to first output logic signals having said first output signal protocol.

10. The apparatus as recited in claim 9, wherein said programmed logic circuit translates said first input logic signals and said second input logic signals to first output logic signals having a second output signal protocol.

11. The apparatus as recited in claim 9, further comprising a second output for transmitting second output logic signals to a receiving device configured for receiving user inputs, wherein said programmed logic circuit translates said first input logic signals and said second input logic signal to first output logic signals having said first output signal protocol and to second output logic signals having a second output signal protocol.

12. The apparatus as recited in claim 11, further comprising a third input for receiving third input logic signals from a third device configured for transmitting user inputs, said third input signals having said first output signal protocol, wherein said programmed logic circuit further passes said third input logic signals to first output logic signals having said first output signal protocol and further translates said third input logic signals to second output logic signals having said second output signal protocol.

13. The apparatus as recited in claim 12, further comprising a fourth input for receiving fourth input logic signals from a fourth device configured for transmitting user inputs, said fourth input signals having said second output signal protocol, wherein said programmed logic circuit further passes said fourth input logic signals to second output logic signals having said second output signal protocol and further translates said fourth input logic signals to first output logic signals having said first output signal protocol.

14. The apparatus as recited in claim 13, further comprising a multichannel driver/receiver for multiplexing input and output logic signals.

15. The apparatus as recited in claim 13, further comprising signal conditioners associated with inputs and outputs.

16. The apparatus as recited in claim 13, further comprising control switches for affecting programming of said programmed logic circuit.

17. The apparatus as recited in claim 13, further comprising display indicators for indicating status of inputs and outputs.

18. An apparatus comprising:
a PS2 input for receiving first input logic signals from a first device configured for transmitting user inputs;
a USB input for receiving second input logic signals from a second device configured for transmitting user inputs;
a RS232 input for receiving third input logic signals from a third device configured for transmitting user inputs;
a TTL input for receiving fourth input logic signals from a fourth device configured for transmitting user inputs;
a programmed logic circuit for translating said first input logic signals, said second input logic signals, said third input logic signals and said fourth input logic signals to first output logic signals having a RS232 output signal protocol, said programmed logic circuit further translating said first input logic signals, said second input logic signals, said third input logic signals and said fourth input logic signals to second output logic signals having a TTL output signal protocol;
a RS232 output for transmitting said first output logic signals to a POS device configured for receiving user inputs; and
a TTL output for transmitting said second output logic signals to a POS device configured for receiving user inputs.

19. The apparatus as recited in claim 18, further comprising a multichannel driver/receiver for multiplexing input and output logic signals.

20. The apparatus as recited in claim 18, further comprising signal conditioners associated with inputs and outputs.
